(19) United States
(12) Patent Application Publication
(10) Pub. No.: US 2024/0191760 A1
(43) Pub. Date: Jun. 13, 2024

(54) BRAKE DEVICE AND ASSEMBLY METHOD THEREOF

(71) Applicant: HYUNDAI MOBIS CO., LTD., Seoul (KR)

(72) Inventor: Bo Ram YOON, Yongin-si (KR)

(73) Assignee: HYUNDAI MOBIS CO., LTD., Seoul (KR)

(21) Appl. No.: 18/199,469

(22) Filed: May 19, 2023

(30) Foreign Application Priority Data
Dec. 13, 2022 (KR) 10-2022-0173837
Dec. 28, 2022 (KR) 10-2022-0187589

(51) Int. Cl. F16D 55/226; F16D 65/00; F16D 65/18; F16D 65/56

(52) U.S. Cl. CPC F16D 55/226; F16D 65/005; F16D 65/18; F16D 65/567; B60T 1/065

(57) ABSTRACT

A brake device includes a brake pad, a pad moving unit connected to the brake pad and configured to linearly move the brake pad, a caliper body having a cylindrical portion for the pad moving unit to be seated therein, and a motor-gear assembly connected to the pad moving unit and transmitting power of a motor. The pad moving unit includes a conversion assembly for converting a rotational motion into a linear motion, and a piston connected to one end of the conversion assembly. The piston is positioned outside the cylindrical portion. The motor-gear assembly is fixed with respect to the caliper body.

Pursuant to 35 U.S.C. § 119(a), this application claims the benefit of earlier filing dates and right of priority to Korean Application No. 10-2022-0173837, filed on Dec. 13, 2022, and No. 10-2022-0187589, filed on Dec. 28, 2022, the contents of which are hereby incorporated by reference herein in their entirety.

### BACKGROUND OF THE DISCLOSURE

### Field of the Disclosure

The present embodiments relate to a brake device applicable to vehicles in all fields, and more particularly, to a brake device connected to a brake disk of a vehicle.

### Discussion of the Related Art

A brake device mounted on a vehicle is a device for decelerating or stopping the traveling vehicle or maintaining the stopped state of the vehicle, and is a device for braking the vehicle by applying a great pressure to a disk-shaped brake disk rotating together with a vehicle wheel from both sides using brake pads.

The brake device is classified into a hydraulic type brake device and a motor-driven type brake device depending on a scheme of obtaining a force for moving the brake pad. In the case of the motor-driven type, because a hydraulic pressure is not used, parts related to the hydraulic pressure are removed, so that a structure of the device is simple and a weight thereof is light. However, when the motor-driven brake device is used for main braking of the vehicle, a required braking force is great and a lot of load is generated on a component for propelling the pad due to a frequent use. Therefore, it is easy to cause breakage of a component.

In the case of the motor-driven brake device, a motor and a gear with considerable weights are connected together to a caliper body. In this regard, the conventional brake device has a problem that a center of gravity of the brake device is biased because the motor and the gear are located at one side of the caliper body.

Because the caliper body may move during a braking operation of the vehicle and is subjected to vibration as the vehicle travels, the biased center of gravity may be unfavorable to a behavior and vibration characteristics of the brake device.

Therefore, there is a need for a technology that reduces the above problems.

An embodiment of the present disclosure is to provide a brake device that reduces the above problems.

Specifically, the embodiment of the present disclosure is to provide a brake device with an improved center of gravity.

In addition, the embodiment of the present disclosure is to provide a brake device with improved behavior and vibration characteristics of a caliper body.

Embodiments of the present disclosure are to provide a brake device that reduces the above problems.

Specifically, the embodiments of the present disclosure are to provide a brake device that reduces a possibility of breakage of parts resulted from main braking.

In addition, the embodiments of the present disclosure are to provide a brake device with improved assembly properties.

In addition, it is to provide a brake device that has an efficient structure of a pad moving component as well as solves the above problems.

The problems to be solved in the present disclosure are not limited to the technical problems mentioned above, and other technical problems not mentioned will be clearly understood by those skilled in the art to which the present disclosure belongs from the description below.

### SUMMARY OF THE DISCLOSURE

According to an aspect of the present disclosure, a brake device includes a brake pad, a pad moving unit connected to the brake pad and linearly moving the brake pad, a caliper body having a cylindrical portion for the pad moving unit to be seated therein, and a motor-gear assembly connected to the pad moving unit and transmitting power of a motor, the pad moving unit includes a conversion assembly for converting a rotational motion into a linear motion, and a piston connected to one end of the conversion assembly, the piston is positioned outside the cylindrical portion, and the motor-gear assembly is fixed in position.

Preferably, the conversion assembly may include a bolt screw rotating around an axis, and a moving nut connected to the bolt screw, and the moving nut may move by the rotation of the bolt screw.

In addition, preferably, one end of the bolt screw may protrude to the outside of the caliper body, the one end of the bolt screw may be connected to a gear, and the gear may be rotated by the motor.

Preferably, the bolt screw may be able to move a predetermined distance in a direction of the axis, and the bolt screw and the gear may be capable of being engaged with each other and rotating in a section equal to or greater than the predetermined distance. In this regard, the bolt screw may have a first shape capable of being engaged with the gear, the gear may have a second shape capable of being engaged with the first shape, and the first shape may extend by a distance equal to or greater than the predetermined distance in the axial direction. Alternatively, the bolt screw may have a first shape capable of being engaged with the gear, the gear may have a second shape capable of being engaged with the first shape, and the second shape may extend by a distance equal to or greater than the predetermined distance in the axial direction.

Preferably, the second shape of the gear may be a hole capable of receiving the one end of the bolt screw therein, the brake device may further include a gear casing for accommodating the gear and the motor therein, and the gear casing may be fixed in position.

In addition, preferably, the brake device may further include a gear boot having one end fixed to the caliper body and the other end fixed to the gear casing. In addition, the brake device may further include a nut boot having one end fixed to the cylindrical portion and the other end fixed to the moving nut.

In addition, preferably, one end of the moving nut may be inserted into the piston, the one end of the moving nut may include a first groove defined therein along a circumference thereof, the piston may include a second groove in an inner surface thereof at a position corresponding to a position of the first groove, and the brake device may further include a seal portion positioned in a space defined by the first groove and the second groove.

In addition, preferably, a surface of the one end of the moving nut and the inner surface of the piston may be spaced apart from each other by an arbitrary distance. In this regard, the arbitrary distance may be equal to or smaller than 2 mm.

In addition, preferably, the cylindrical portion may include a third groove defined therein along an edge of an opening, the moving nut may include a fourth groove defined therein along a circumference of an outer circumferential surface thereof, and the nut boot may be fixed by the third groove and the fourth groove.

According to another aspect of the present disclosure, in a brake device, a motor and a gear connected to the motor are accommodated in a casing, and the casing is fixed in position, and a caliper body is connected to the casing so as to be able to move in parallel with a moving direction of a brake pad.

According to another aspect of the present disclosure, a brake device includes a caliper body that is a body of the brake device, an actuator connected to the caliper body so as to move the brake pad, and a motor for driving the actuator, and the motor is fixed in position, and the caliper body is movably connected to the motor.

According to another aspect of the present disclosure, a brake device includes a pad moving unit for linearly moving a brake pad, and a caliper body having a cylindrical portion for the pad moving unit to be seated therein, a portion or an entirety of the pad moving unit is able to be inserted into the cylindrical portion, and a space of the cylindrical portion is opened in a direction toward the brake pad, the pad moving unit operates in connection with the motor, and the caliper body includes a passage extending through an edge of the space of the cylindrical portion and connected to the outside of the caliper body.

Preferably, gas or liquid may be transferred from the outside of the caliper body to the cylindrical portion via the passage.

In addition, preferably, the brake device may further include a cylinder connection port positioned in the passage and having a flow channel defined therein leading from the outside of the caliper body to the cylindrical portion. In this regard, the cylinder connection port may be able to open and close the flow channel. One end of the cylinder connection port may protrude inwards from the edge of the cylindrical portion, and the moving nut may include a guide slidably engaged with the one end of the cylinder connection port.

Preferably, the guide may have a length twice or greater than a maximum wear amount of the brake pad. In addition, a predetermined gap may be defined between an opening of the flow channel defined at the one end of the cylinder connection port and the moving nut.

According to another aspect of the present disclosure, a method for assembling a brake device includes assembling a conversion assembly to a cylindrical portion of a caliper body, assembling a piston boot to an opening of the cylindrical portion, injecting gas into the cylindrical portion via a passage of the caliper body, and connecting and assembling a piston to the piston boot.

According to the embodiment of the present disclosure, the behavior and the vibration characteristics of the brake device are improved.

According to the embodiment of the present disclosure, the compact design of the caliper body is possible.

According to the embodiment of the present disclosure, it is advantageous to apply a high-output motor and gear structure.

According to the embodiment of the present disclosure, the durability of the brake device is improved.

According to the embodiment of the present disclosure, the ease of assembly of the brake device is improved.

Effects obtainable from the present disclosure are not limited to the effects mentioned above, and other effects not mentioned will be clearly understood by those skilled in the art from the description below.

### BRIEF DESCRIPTION OF THE DRAWINGS

FIG. 1 shows a brake device 100, a brake disk, and a knuckle assembly according to an embodiment of the present disclosure.

FIG. 2 shows that a brake device in FIG. 1 is separated.

FIG. 3 is a perspective view of a brake device according to an embodiment of the present disclosure.

FIG. 4 is an exploded view of a brake device in FIG. 3.

FIG. 5 is a side view of a brake device according to an embodiment of the present disclosure.

FIG. 6 shows components in FIG. 5 excluding a brake pad, a pad carrier, and a connecting pin.

FIG. 7 shows components of a brake device in FIG. 6 excluding a gear casing.

FIG. 8 shows a cross-section of a brake device in FIG. 6.

FIG. 9 is an enlarged view of a portion in FIG. 8.

FIG. 10 is a perspective view of one cross-section of a brake device.

FIGS. 11A and 11B illustrate a movement of a caliper body based on a movement of a brake pad.

FIG. 12 is a perspective view of a brake device according to another embodiment of the present disclosure.

FIG. 13 is a side view of a brake device.

FIG. 14 is a side view of a brake device.

FIG. 15 is a cross-sectional view of a brake device.

FIG. 16 shows a pad moving unit and a cylinder connection port of a brake device.

FIG. 17 shows a pad moving unit and a cylinder connection port of a brake device.

FIG. 18 shows a cross-sectional view of a caliper body of a brake device 200.

FIG. 19 is a cross-sectional view of a brake device, and is an enlarged view of a partial area.

FIG. 20 shows a method for assembling a brake device.

### DETAILED DESCRIPTION OF THE DISCLOSURE

Advantages and features of the present disclosure, and a method for achieving the same, will become apparent with reference to the embodiments described below in detail in conjunction with the accompanying drawings. However, the present disclosure may not be limited to the embodiments disclosed below, but may be implemented in a variety of different forms. The present embodiments are provided only to ensure that the disclosure of the present disclosure is complete, and to completely inform those skilled in the art to which the present disclosure belongs, the scope of the present disclosure. The present disclosure is only defined by the scope of the claims.

The terminology used herein is for the purpose of describing the embodiments only and is not intended to limit the present disclosure. As used herein, the singular forms “a” and “an” are intended to include the plural forms as well, unless the context clearly indicates otherwise. As used herein, “comprises” and/or “comprising” do not exclude the presence or addition of one or more other components in addition to a stated component. Like reference numerals refer to like components throughout the specification, and “and/or” includes each of the mentioned components and every combination of one or more of the components. Although “first”, “second”, and the like are used to describe various components, it is apparent that such components are not limited by such terms. Such terms are only used to distinguish one component from another. Accordingly, it is apparent that the first component mentioned below may be the second component within the technical spirit of the present disclosure.

Unless otherwise defined, all terms including technical and scientific terms used herein have the same meaning as commonly understood by one of ordinary skill in the art to which the present disclosure belongs. In addition, terms defined in a commonly used dictionary are not to be interpreted ideally or excessively unless specifically defined explicitly.

Spatially relative terms “below”, “beneath”, “lower”, “above”, “upper”, and the like may be used to easily describe a correlation between one component and other components as shown in the drawings. Spatially relative terms should be understood as terms including different directions of the components during use or operation in addition to directions shown in the drawings. For example, when a component shown in the drawings is flipped, a component described as being located “below” or “beneath” another component may be placed “above” said another component. Accordingly, the exemplary term “below” may include both downward direction and upward direction. Components may also be oriented in other directions, and thus, spatially relative terms may be interpreted based on the orientation.

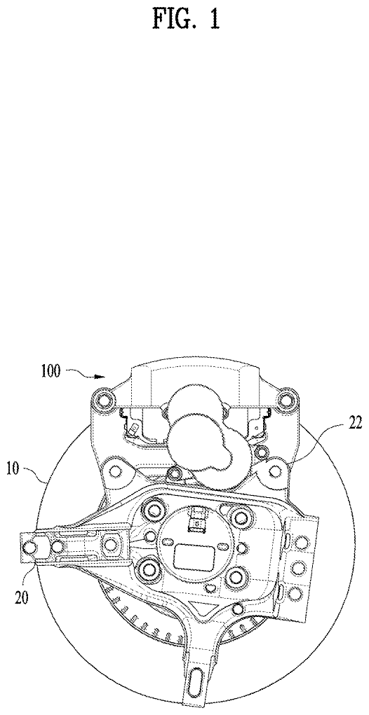

FIG. 1 shows a brake device 100 (hereinafter, “brake device”), a brake disk 10, and a knuckle assembly 20 according to an embodiment of the present disclosure. Referring to FIG. 1, the brake device 100 is connected to the knuckle assembly 20. The knuckle assembly 20 may include a plurality of fixing holes 22 for fixing the brake device 100, and the brake device 100 may be fixed at an arbitrary position of the knuckle assembly 20.

The brake device 100 may be disposed on an edge of the brake disk 10, and a brake pad 130 mounted inside the brake device 100 may press the brake disk 10. Therefore, braking may be applied to a wheel of a vehicle.

The knuckle assembly 20 may be connected to the wheel of the vehicle. A position and an orientation of the knuckle assembly 20 are constant regardless of rotation of the vehicle wheel. On the other hand, the brake disk 10 rotates together with the rotation of the wheel of the vehicle. The knuckle assembly 20 and the brake disk 10 according to the embodiments may respectively represent a knuckle and a brake disk commonly referred to in the art to which the present disclosure belongs.

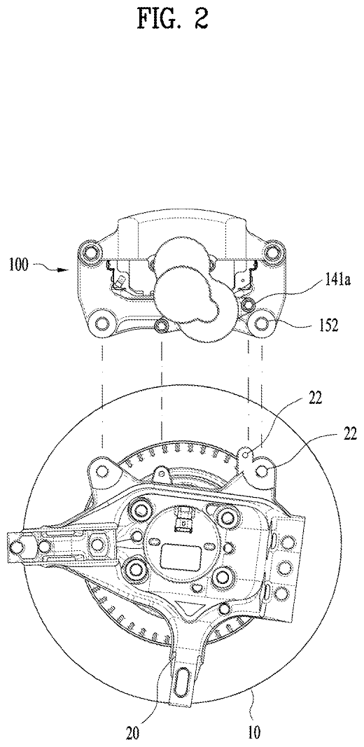

FIG. 2 shows that the brake device 100 in FIG. 1 is separated. Referring to FIG. 2, the knuckle assembly 20 includes the plurality of fixing holes 22. Each of the plurality of fixing holes 22 may be connected to each of fixing portions of the brake device 100. The brake device 100 includes a gear casing fixing portion 141a and a carrier fixing portion 152, and the gear casing fixing portion 141a and the carrier fixing portion 152 are respectively formed on a gear casing 141 and a pad carrier 150. A scheme in which the brake device 100 is fixed to the knuckle assembly 20 may include a variety of possible schemes that may be applied by those skilled in the art as well as a pin connection scheme shown in the drawing.

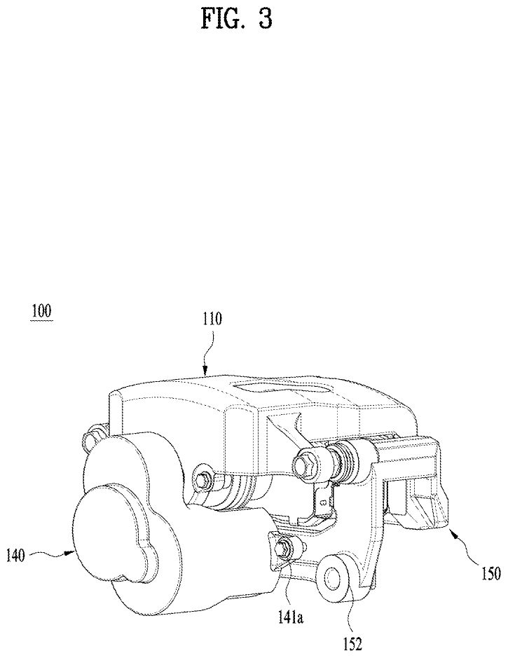

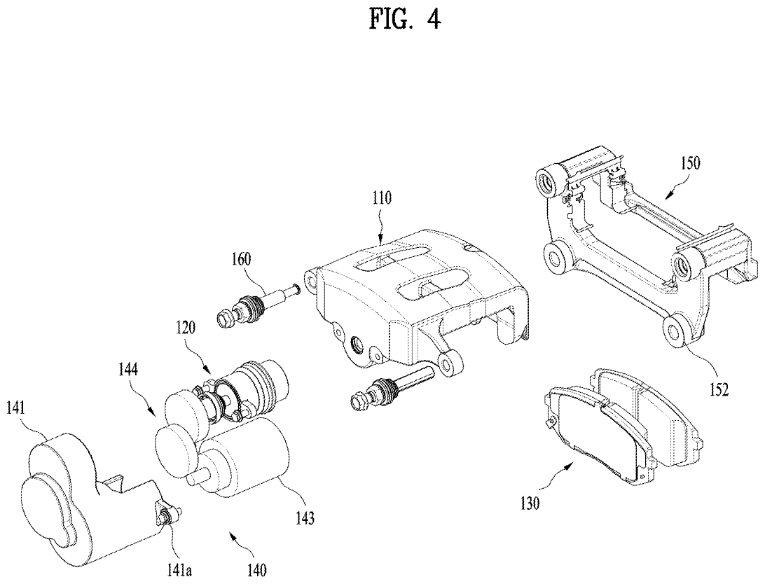

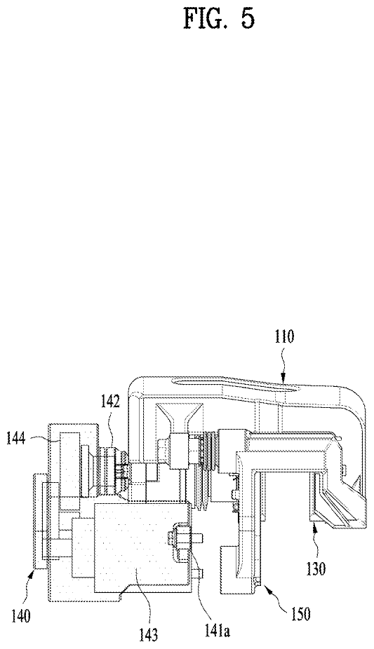

FIG. 3 is a perspective view of the brake device 100, and FIG. 4 is an exploded view of the brake device 100. FIG. 5 is a side view of the brake device 100. FIG. 5 shows components located inside the gear casing 141 together. Referring to FIGS. 3 to 5, the brake device 100 includes a caliper body 110, a pad moving unit 120, the brake pad 130, a motor-gear assembly 140, the pad carrier 150, and/or a connecting pin 160.

The caliper body 110 may provide a space in which components of the brake device 100 (e.g., the pad moving unit, the brake pad, and the like) may be fixed or seated, and may guide a movement of the brake pad 130. The caliper body 110 may be composed of a combination of a plurality of parts.

The caliper body 110 is a body capable of connecting the components of the brake device 100 to each other. The caliper body 110 may be formed in a shape similar to a ‘ [symbol] ’ shape, and a portion of the brake disk may be located in a concave area. The brake pads 130 may be positioned inside the caliper body 110 so as to press both surfaces of the brake disk.

The caliper body 110 includes a cylindrical portion 112. The cylindrical portion 112 may be a casing including a cylindrical inner space, or may represent a cylindrical inner space integrally defined in the caliper body 110. Shapes of the inner space of the cylindrical portion 112 may be various. The pad moving unit 120 may be located in the inner space of the cylindrical portion 112, and the cylindrical portion 112 may guide a movement of the pad moving unit 120. As one surface of the space of the cylindrical portion 112 is open, the pad moving unit 120 may move the brake pad 130 via the open surface.

The caliper body 110 may be connected to the pad moving unit 120, and the pad moving unit 120 may be connected to the motor-gear assembly 140 to receive power. The pad moving unit 120 may move the brake pad 130 with the power transmitted from the motor-gear assembly 140.

A material and a shape of the caliper body 110 may be variously determined in consideration of positions, loads, and the like of other components. The caliper body 110 may be made of a metal-based material having appropriate strength so as to support a reaction force against a braking clamping force.

The pad carrier 150 may be connected to the caliper body 110 by the connecting pin 160, and may be connected to both side surfaces of the brake pad 130 to guide the brake pad 130. The brake pad 130 has protrusions formed on the both side surfaces, and the pad carrier 150 includes grooves respectively corresponding to the protrusions. Accordingly, the protrusion of the brake pad 130 may be inserted into the groove of the pad carrier 150. In addition, the groove of the pad carrier 150 extends along a moving direction of the brake pad 130. The protrusions on the both side surfaces of the brake pad 130 may move while being guided by the pad carrier 150.

The pad carrier 150 may be connected to a fixed component such as the knuckle assembly 20 of the vehicle wheel, and the caliper body 110 connected to the pad carrier 150 may move while being guided along a direction of the connecting pin 160. The pad carrier 150 may include at least one carrier fixing portion 152, and the carrier fixing portion 152 may be constructed as appropriate fixing means such that the pad carrier 150 is fixed to the fixing hole 22 of the knuckle assembly 20.

Because the pad carrier 150 is connected to the knuckle assembly 20 via the carrier fixing portion 152, the pad carrier 150 is fixed in position like the knuckle assembly 20. Accordingly, the position of the pad carrier 150 itself is fixed, but the caliper body 110 may move along the direction of the connecting pin 160. During a braking operation, the caliper body 110 may move due to a reaction force of the brake pad 130 of pushing the brake disk. The direction of the connecting pin 160 is parallel to a direction in which the brake pad 130 moves.

The pad carrier 150 may be fixed not only to the knuckle assembly 20 but also to another component whose position is fixed on the wheel of the vehicle.

The pad carrier 150 may be made of a metal-based material having appropriate strength to support a braking torque acting on the brake pad 130.

The brake pad 130 may be composed of a pad that is in direct contact with and rubs against the brake disk and a plate connected to one surface of the pad. The brake pad 130 may include a plurality of brake pads, and a first brake pad may press one side surface of the brake disk and a second brake pad may press the other side surface of the brake disk. That is, a pair of brake pads 130 may be disposed in the caliper body 110 or the pad carrier 150 in a state facing each other with the brake disk interposed therebetween.

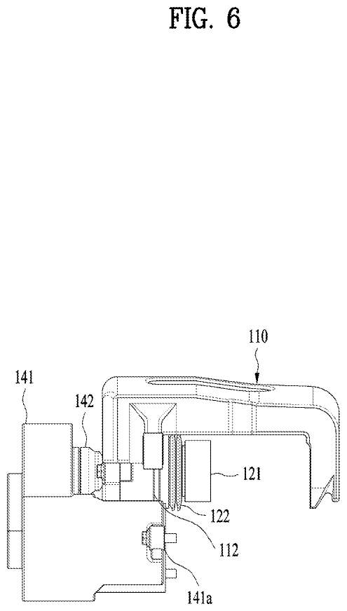

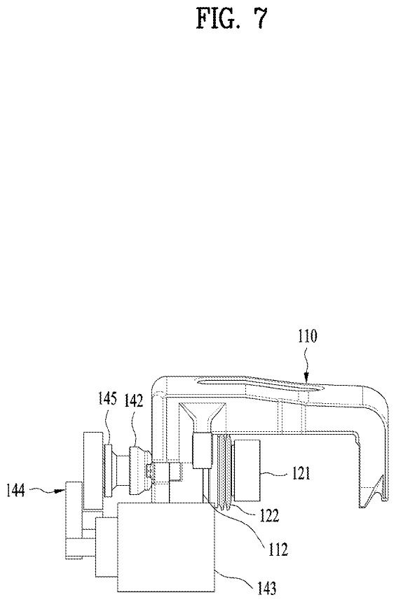

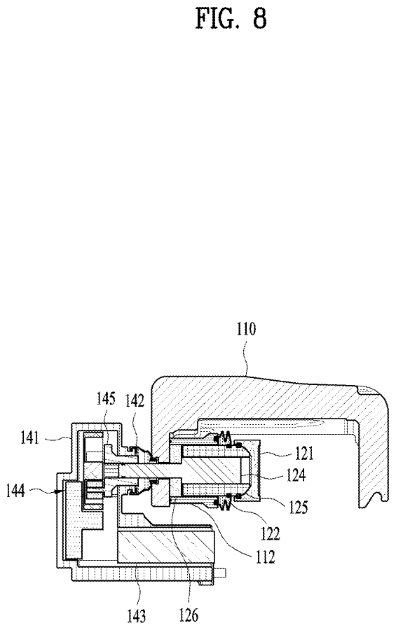

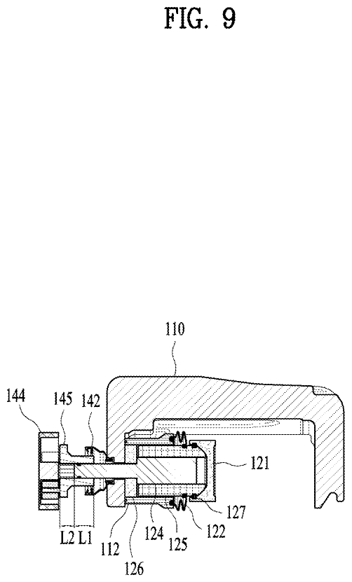

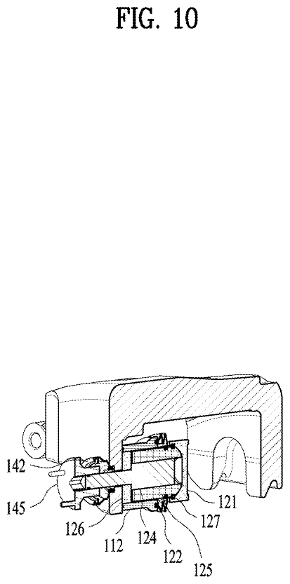

FIG. 6 shows the components in FIG. 5 excluding the brake pad 130, the pad carrier 150, and the connecting pin 160. FIG. 7 shows the components of the brake device in FIG. 6 excluding the gear casing 141. FIG. 8 shows a cross-section of the brake device in FIG. 6, and FIG. 9 is an enlarged view of a portion in FIG. 8. FIG. 10 is a perspective view of one cross-section of a brake device.

In the drawings for illustrating the embodiments of the present disclosure, components other than components to be described may be omitted.

Referring to FIGS. 6 to 10, the pad moving unit 120 may include a piston 121, a nut boot 122, and conversion assembly 124 and 125. The conversion assembly 124 and 125 may include a bolt screw 124 and a moving nut 125.

The conversion assembly may represent various components capable of converting rotational motion of a gear into linear motion and a connection scheme between the components. In this embodiment, the conversion assembly may include a bolt screw 124 and a moving nut 125 corresponding thereto. The conversion assembly may be positioned in the space of the cylindrical portion 112.

The bolt screw 124 is engaged with a gear 145 connected to a motor 143 and rotates around an axis. The bolt screw 124 may be positioned at a center of the cylindrical portion 112 to be directed in an axial direction. The axial direction of the bolt screw 124 is parallel to the direction in which the brake pad 130 moves (advances or retreats). The bolt screw 124 is positioned within the space of the cylindrical portion 112 of the caliper body 110 and rotates in place. A screw thread may be formed on an outer surface of the bolt screw 124, and the moving nut 125 connected to the screw thread may move linearly by the rotation of the bolt screw 124.

One end of the bolt screw 124 protrudes to the outside of the caliper body 110. In addition, the protruding end of the bolt screw 124 is connected to the motor-gear assembly 140. The bolt screw 124 may be rotated in connection with the gear 145 that receives power of the motor 143. The motor-gear assembly 140 may include the motor 143 and a gear assembly connected to the motor 143.

The moving nut 125 may have a screw corresponding to the screw of the bolt screw 124, and may be connected to the bolt screw 124 to move forward or backward based on a rotation direction of the bolt screw 124. The moving nut 125 may protrude out of the space of the cylindrical portion 112 or be withdrawn into the cylindrical portion 112 during the movement. The moving nut 125 may move along a length direction of the cylindrical portion 112.

A length of the moving nut 125 is great enough such that a head (a piston-connected portion) thereof protrudes out of the cylindrical portion 112 even when the moving nut 125 is inserted all the way into the cylindrical portion 112. That is, the length of the moving nut may be greater than a length of the cylindrical portion 112. When a bearing is positioned inside the cylindrical portion 112, the length of the moving nut may be greater than the length of the cylindrical portion 112 minus a thickness of the bearing.

The pad moving unit 120 may further include a bearing 126 connected to the bolt screw 124. The bearing 126 may include one or more bearings 126, and may be positioned at the rear of a tail of the moving nut 125. The bearing 126 includes a screw bearing and keeps the position of the bolt screw 124 constant.

A portion of the moving nut 125 is positioned inside the cylindrical portion 112, and the movement of the moving nut 125 is guided by the direction of the cylindrical portion 112. The moving nut 125 may also be referred to as a ball screw nut. In addition, a structure of the bolt screw 124 and the moving nut 125 according to the embodiments may be referred to as a ball screw structure. The conversion assembly in which the bolt screw 124 and the moving nut 125 are connected to each other may include a conventional ball screw structure.

In one example, one end of the piston 121 is connected to the brake pad 130 and the other end thereof is connected to the head of the moving nut 125, so that the movement of the moving nut 125 is transferred to the brake pad 130. A shape of the piston 121 may include a cylindrical shape with one surface open, and the moving nut 125 may be connected to the piston 121 as the head thereof is inserted via the open surface. That is, the head of the moving nut 125 (the portion protruding out of the cylindrical portion) is connected to the piston 121. Accordingly, when the moving nut 125 moves forward or backward, the piston 121 and the brake pad 130 connected to the moving nut 125 may move forward or backward together.

The piston 121 may not be inserted into the space of the cylindrical portion 112, and a cross-sectional diameter of the piston 121 may be larger than that of the cylindrical portion 112. Accordingly, the piston 121 is positioned outside the cylindrical portion 112.

The head of the moving nut 125 may include a curved surface, and the piston 121 may include a corresponding curved surface on one surface thereof close to the head of the moving nut 125. For example, when the head of the moving nut 125 includes a convex surface, the corresponding surface of the piston 121 may include a concave surface. The curved surface of the moving nut 125 and the curved surface of the piston 121 may correspond to each other and may be in contact with each other.

A seal portion 127 is a component that blocks a gap generated between the piston 121 and the head of the moving nut 125. The seal portion 127 blocks foreign substances from flowing into the piston 121.

The moving nut 125 includes a first groove defined along a circumference of the head, and the piston 121 includes a second groove whose position corresponds to that of the first groove in an inner surface thereof. When the piston 121 and the moving nut 125 are connected to each other, the first groove and the second groove face each other, and a space in which the seal portion 127 may be positioned is defined by the first groove and the second groove. Accordingly, the seal portion 127 may be positioned in the space defined by the first groove of the moving nut 125 and the second groove of the piston 121.

The seal portion 127 may have a shape formed along the space defined by the first groove of the moving nut 125 and the second groove, and may include various shapes depending on a cross-sectional shape of the moving nut 125. In addition, a cross-section of the seal portion 127 may be formed in a rectangular or circular shape, and shapes of the first groove and the second groove may be changed to correspond to the cross-sectional shape of the seal portion 127. The seal portion 127 may include components, materials, and the like commonly used for sealing.

The seal portion 127 blocks the gap between the moving nut 125 and the piston 121, and connects the moving nut 125 and the piston 121 to each other so as not to be separated from each other. In this regard, the moving nut 125 and the piston 121 may be connected to each other while a surface of the head of the moving nut 125 and an inner surface of the piston 121 are spaced apart from each other by a predetermined distance. That is, in an absence of external force, the curved surface of the head of the moving nut 125 and the corresponding curved surface of the piston 121 may be spaced apart from each other by an arbitrary distance (or spacing). In this regard, the arbitrary distance may be equal to or smaller than 2 mm.

The piston 121 is capable of flexible movement within a range permitted by the above-mentioned arbitrary spacing. Therefore, an axial direction of the piston 121 may be slightly inclined differently from an axial direction of the moving nut 125.

In a case in which the pad of the brake pad 130 is asymmetrically worn, when the brake pad 130 presses the brake disk, the brake pad 130 receives an external force so as to be inclined because of an inclination of a pad surface that is worn at one side. However, because the brake pad 130 of the brake device 100 according to the embodiment may be slightly inclined, a magnitude of an external force applied to the piston 121 or the moving nut 125 is significantly reduced and a possibility of breakage is low.

In addition, the spacing between the moving nut 125 and the piston 121 may improve a return performance of the brake pad 130 and prevent a collision between the moving nut 125 and the piston 121 caused by vehicle vibration. Because the collision between the piston 121 and the moving nut 125 is prevented, noise of the device may be reduced and durability may be improved.

The moving nut 125 may allow the piston 121 to move forward only when moving forward by the above-mentioned arbitrary distance or more and then coming into contact with the piston 121 and transmitting the pressure to the piston 121. In case of backward movement, the moving nut 125 may allow the piston 121 to move backward only when moving backward by the corresponding distance or more. A section in which only the moving nut 125 moves without moving the piston 121 during the forward movement or the backward movement may be referred to as an invalid stroke section, and the invalid stroke section may be set to be equal to or smaller than 2 mm. That is, the aforementioned arbitrary distance may be set to be equal to or smaller than 2 mm.

Referring to FIGS. 6 to 10, the brake device 100 further includes the motor-gear assembly 140. The motor-gear assembly 140 may be connected to the protruding end of the bolt screw 124. The motor-gear assembly 140 includes the gear casing 141, the motor 143, and a gear assembly 144.

An operation of the motor 143 may be controlled based on an electrical signal. When the motor 143 is operated, a rotational motion of the motor is transmitted to the bolt screw 124 via the gear assembly 144. The motor 143 may be disposed at a center in a left and right direction of the brake device 100. That is, the motor 143 may be disposed at and connected to a center in the left and right direction of the caliper body 110.

The gear assembly 144 may be constructed as an assembly of a plurality of gears for transmitting the rotational motion of the motor 143. The plurality of gears may be connected to the motor 143 and connected to the protruding end of the bolt screw 124. Accordingly, the plurality of gears may transmit the rotation of the motor 143 to the bolt screw 124. There may be various structures, including the numbers, positions, sizes, and the like, of the plurality of gears devised by a person skilled in the art. The plurality of gears may be constructed as a combination of various gear structures such as a spur gear, a helical gear, and a worm gear.

The gear casing 141 may accommodate the motor 143 and the gear assembly 144 therein. the gear casing 141 may fix positions of the motor 143 and the gear assembly 144. The gear casing 141 may include at least one casing fixing portion 141a, and the casing fixing portion 141a may be formed as appropriate fixing means such that the gear casing 141 is fixed to the fixing hole 22 of the knuckle assembly 20. Because the gear casing 141 is connected to the knuckle assembly 20 via the casing fixing portion 141a, a position thereof may be fixed like the knuckle assembly 20. Therefore, the positions of the motor 143 and the gear assembly 144 accommodated in the inner space of the gear casing 141 are also fixed. The gear casing 141 may be fixed to other components with fixed positions as well as to the knuckle assembly 20. For example, the gear casing 141 may be fixed to a bracket, a stator, or the like fixed around the caliper body 110, or to the pad carrier 150.

When the gear casing 141 is directly connected to the caliper body 110, weights of the gear assembly 144 and the motor 143 are on one side of the caliper body 110 and a center of gravity of the caliper body 110 is biased to one side. When the center of gravity of the caliper body 110 is biased, the caliper body 110 may be more affected by the vibration during the traveling of the vehicle, which may adversely affect a behavior of the caliper body 110. In particular, when a motor with a great output is used to improve a braking performance, the center of gravity of the caliper body 110 may be further biased because the size and the weight of the motor increase.

In the brake device 100 according to the present embodiments, because the gear casing 141 is fixed to the knuckle assembly 20, the weights of the motor 143 and the gear assembly 144 are supported by the knuckle assembly 20 and are not loaded on the caliper body 110. Therefore, there is the effect of improving the behavior characteristics of the caliper body 110.

Hereinafter, the connection between the protruding end of the bolt screw 124 and the gear assembly 144 will be described.

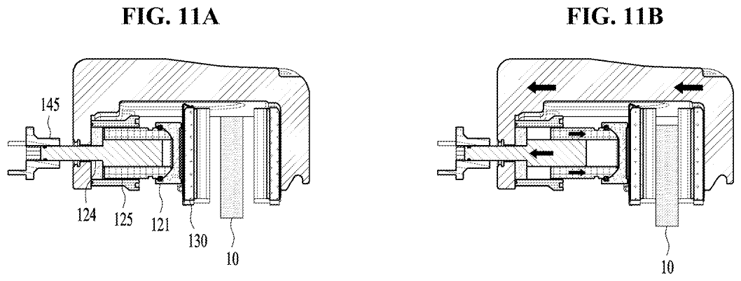

FIGS. 11A and 11B illustrate a movement of the caliper body 110 based on the movement of the brake pad 130. FIG. 11A shows a position of the brake pad 130 in normal times, and FIG. 11B shows that the moving nut 125 moves forward and the brake pad 130 comes into contact with the brake disk 10. In FIG. 11B, arrows indicate moving directions of components.

Referring to FIG. 11B, the bolt screw 124 may move together with the caliper body 110. In FIG. 11B, when a left brake pad 130 among the pair of brake pads 130 comes into contact with one side surface of the brake disk 10, the caliper body 110 moves in an opposite direction by a reaction force thereafter as much as the moving nut 125 moves forward, and a right brake pad 130 moves together with the caliper body 110 and comes into contact with the other side surface of the brake disk 10.

As such, the bolt screw 124 may move during the braking process, and the connection between the gear assembly 144 and the bolt screw 124 is maintained during the movement of the bolt screw 124. That is, regardless of the position of the bolt screw 124, the power of the motor 143 may be transmitted while the gear assembly 144 and the bolt screw 124 are engaged with each other and rotated.

The bolt screw 124 may move a predetermined distance in the axial direction, and the bolt screw 124 may rotate by being engaged with the gear 145 (see FIGS. 7 to 10) of the directly connected gear assembly 144. Because the bolt screw 124 moves the predetermined distance during the braking operation, the bolt screw 124 and the gear 145 may be engaged with each other in a section equal to or greater than the predetermined distance.

The protruding end of the bolt screw 124 has a first shape engageable with the gear 145, and the gear 145 has a second shape engageable with the first shape.

There may be following embodiments for the bolt screw 124 and the gear 145 to be engaged with each other in the section equal to or greater than the predetermined distance.

As one embodiment, the first shape of the bolt screw 124 may be formed by extending by a length equal to or greater than a predetermined distance along the axial direction. Therefore, even when the bolt screw 124 moves in the axial direction, the first shape and the second shape of the gear 145 may be engaged with each other.

As another embodiment, the second shape of the gear 145 may be formed by extending by a length equal to or greater than a predetermined distance along the axial direction. Therefore, even when the bolt screw 124 moves in the axial direction, the first shape and the second shape of the gear 145 may be engaged with each other.

As another embodiment, the first shape of the bolt screw 124 and the second shape of the gear 145 may extend by a length equal to or greater than the predetermined distance. Even when the bolt screw 124 moves the predetermined distance in the axial direction, the first shape and the second shape are always engaged with each other.

Referring to FIGS. 9 and 10, the protruding end of the bolt screw 124 has the first shape, and the second shape of the gear 145 is formed as a hole that may be engaged with the first shape. Therefore, the protruding end of the bolt screw 124 is inserted into and engaged with the second shape of the gear 145, and when the gear 145 rotates, the bolt screw 124 also rotates.

The length of the second shape (L1+L2, see FIG. 9) into which the protruding end of the bolt screw 124 may be inserted is at least greater than the predetermined distance that the bolt screw 124 moves. In FIG. 9, L1 is a length of a section in which the first shape of the bolt screw 124 and the second shape of the gear 145 are engaged with each other in normal times. L2 in FIG. 9 is a length of a section in which the second shape is extended in preparation for the movement of the bolt screw 124. L2 is at least greater than the predetermined distance that the bolt screw 124 moves. In this regard, the predetermined distance may be in a range from 4 mm to 13 mm.

The moving distance of the bolt screw 124 may be determined by a wear thickness of the brake pad 130. A maximum wear thickness may be set based on the brake pad 130, and a maximum distance that the bolt screw 124 may move may be determined based on the maximum wear thickness. Therefore, the length of the section in which the first shape or the second shape extends may be based on the maximum wear thickness of the brake pad 130.

In FIG. 9, even when the bolt screw 124 moves to the left, the second shape of the gear 145 may accommodate therein the protruding end of the bolt screw 124. Therefore, the connection between the gear 145 and the bolt screw 124 is maintained, and the power of the motor 143 is continuously transmitted. The section in which the bolt screw 124 and the gear 145 may be engaged with each other has a length equal to or greater than the predetermined distance in preparation for the movement of the bolt screw 124.

The brake device 100 may further include a gear boot 142 and the nut boot 122.

The nut boot 122 blocks a gap between an edge of the cylindrical portion 112 and an outer surface of the moving nut 125 to block the inflow of the foreign substances from the outside.

The cylindrical portion 112 includes a third groove defined along an edge of an opening thereof, and the moving nut 125 includes a fourth groove defined along a circumference of an outer circumferential surface thereof. The fourth groove is positioned outside the cylindrical portion 112. One end of the nut boot 122 is inserted into and fixed to the third groove, and the other end of the nut boot 122 is inserted into and fixed to the fourth groove. The nut boot 122 is formed with a plurality of creases, so that the nut boot 122 may be flexibly deformed even when a position of the moving nut 125 changes, and the foreign substances may be prevented from entering the gap between the moving nut 125 and the cylindrical portion 112.

The gear boot 142 blocks the foreign substances from entering the area where the protruding end of the bolt screw 124 and the gear assembly 144 are connected to each other.

The caliper body 110 includes a fifth groove defined along an edge of a hole through which the bolt screw 124 extends. The gear casing 141 includes an opening such that the end of the bolt screw 124 may enter the inner space of the casing, and includes a sixth groove defined along an edge of the opening. The gear boot 142 has one end connected to the fifth groove and the other end connected to the sixth groove, so that the foreign substances may be blocked from entering through a portion of the bolt screw 124 exposed between the gear casing 141 and the caliper body 110.

In the brake device 100 according to the embodiments, the motor 143 and the gears connected to the motor 143 may be accommodated in the gear casing 141 and the gear casing 141 may be fixed to the knuckle assembly 20 of the vehicle wheel. That is, the position of the gear casing 141 is fixed. Here, the fact that the position is fixed does not mean that a position on a map is fixed based on the traveling of the vehicle, but that the component is fixed at a constant position on the wheel of the vehicle. Specifically, it may indicate that a relative position with the brake disk 10 is fixed, and the rotation of the brake disk 10 is not considered at this time.

The gear casing 141 may be fixed to other components with the fixed positions as well as to the knuckle assembly 20. For example, the gear casing 141 may be fixed to the bracket, the stator, or the like fixed around the caliper body 110, or to the pad carrier 150.

In addition, in the brake device 100 according to the embodiments, the pad moving unit 120 may be referred to as an actuator.

In the brake device 100 according to the embodiments, the position of the motor 143 may be fixed on the wheel of the vehicle, and the caliper body 110 may be movably connected to the motor 143.

According to the embodiments of the present disclosure, because a weight acting on the caliper body 110 is reduced, a diameter of the connecting pin 160 supporting the weight of the caliper body 110 may be reduced. In addition, a size of a hole into which the connecting pin 160 is inserted is reduced as much as the diameter of the connecting pin 160 is reduced, so that the caliper body 110 and the pad carrier 150 may secure rigidity. Such advantage helps with a compact design of the caliper body 110 and the pad carrier 150.

In addition, according to the embodiments of the present disclosure, as the weight of the caliper body 110 decreases, noise characteristics such as rattle are reduced and a resistance based on the movement of the caliper body 110 is reduced, so that a behavioral performance of the caliper body 110 is improved. In addition, limiting conditions of the design based on the size and the weight of the motor are alleviated, which has an effect of increasing a degree of freedom of the design.

A brake device 200 (hereinafter, referred to as a “brake device”) according to another embodiment of the present disclosure will be described.

The technical features of the brake device 100 according to the embodiment described above and those of the brake device 200 to be described below may be combined with each other. That is, features of components may be combined with each other for a purpose of improving the behavior and the vibration characteristics of the brake device.

In relation to the descriptions of the brake device 100 according to the above-described embodiment and the brake device 200 to be described below, components may be represented with different reference numerals in embodiments and terms representing a corresponding component may be different from each other in the embodiments.

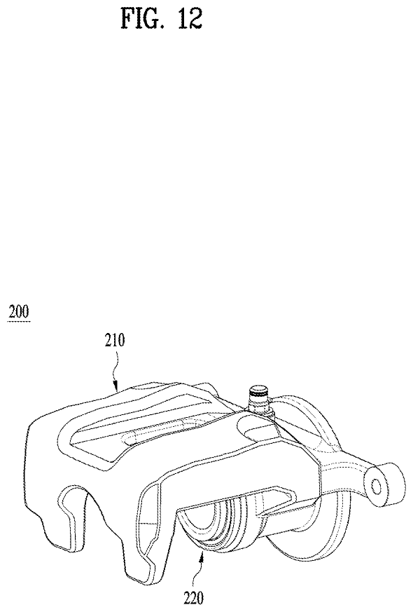

FIG. 12 shows the brake device 200 (hereinafter, referred to as the “brake device”) according to another embodiment of the present disclosure. The drawings show components related to the technical idea of the present disclosure with respect to the brake device 200, and some components may be omitted. However, the components omitted in the drawings may also be described, and may be components of the brake device 200.

Although not shown in the drawing, the brake device 200 may further include a brake pad (not shown) and a pad carrier (not shown).

The brake device 200 puts the brakes on the wheel by moving the brake pad and rubbing the brake pad with the brake disk of the vehicle. During the traveling, the brake disk may rotate together with the wheel, and when the brake pad applies a pressure to the brake disk, the brake disk may reduce a rotation speed of the wheel by providing a resistance to the rotation of the wheel.

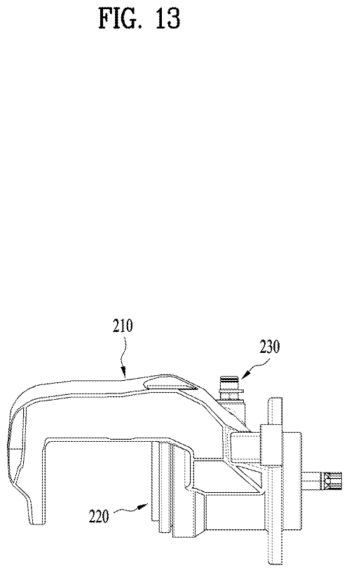

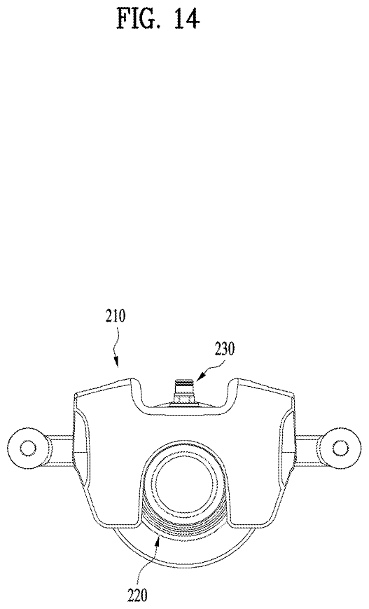

Each of FIGS. 13 and 14 shows one side surface of the brake device 200.

Referring to FIGS. 12 to 14, the brake device 200 may include a caliper body 210, a pad moving unit 220, and a cylinder connection port 230.

The caliper body 210 is a body capable of connecting the components of the brake device 200 to each other. The caliper body 210 may be formed in a shape similar to a ‘ [symbol] ’ shape, and a portion of the brake disk may be located in a concave area. The brake pad may be positioned inside the caliper body 210 so as to press both surfaces of the brake disk. In addition, the caliper body 210 may include a cylindrical portion 212 in which the pad moving unit 220 that moves the brake pad is seated. The cylindrical portion 212 is defined as a space capable of accommodating the pad moving unit 220 therein. In addition, because the space of the cylindrical portion 212 is open in a direction toward the brake pad, the pad moving unit 220 may be connected to the brake pad.

In addition, the caliper body 210 includes a passage 214 for connecting the space of the cylindrical portion 212 with the outside. The caliper body 210 may include the passage 214 that extends through an edge of the space of the cylindrical portion 212 and is connected to the outside of the caliper body 210. Accordingly, liquid, gas, or the like may be injected into the space of the cylindrical portion 212 from the outside via the passage 214. The passage 214 may function as a flow channel through which various fluids may pass. The liquid transported via the passage 214 may include lubricating oil, braking liquid, grease, or the like.

The passage 214 may be connected to the space of the cylindrical portion 212 through the caliper body 210 at various points of the caliper body 210. The passage 214 may be defined in a straight or curve shape, and a diameter of the passage 214 may be set to an arbitrary dimension.

When the lubricating oil or the grease is injected into the space of the cylindrical portion 212 via the passage 214, a resistance received during operation of the pad moving unit 220 may be reduced because of the lubricating oil and durability and behavioral performance of components of the pad moving unit 220 may be improved.

Injecting the gas into the space of the cylindrical portion 212 via the passage 214 may be advantageous when assembling a piston 221 of the pad moving unit 220 in the brake device 200. For example, in a process of connecting a piston boot 224 to the piston 221, the gas introduced into the cylindrical portion 212 allows the folded piston boot 224 to be unfolded, thereby easily connecting the piston 221 to the piston boot 224.

A type and characteristics of the fluid transported via the passage 214 may vary depending on a purpose of use.

A material and a shape of the caliper body 210 may be variously determined in consideration of positions, loads, and the like of other components. Preferably, the material of the caliper body 210 includes a metal-based material. The caliper body 210 may be made of a metal-based material having appropriate strength to support a reaction force against a braking clamping force.

The pad carrier (not shown) is connected to the caliper body 210, and connected to both side surfaces of the brake pad to guide the movement of the brake pad. The brake pad has protrusions on the both side surfaces, and the pad carrier has grooves respectively corresponding to the protrusions, so that the protrusions of the brake pad may be inserted into the grooves of the pad carrier.

The groove of the pad carrier extends along the direction in which the brake pad moves to press the brake disk. Therefore, the brake pad may move as the protrusions on the both side surfaces thereof are guided by the pad carrier.

The pad carrier may be connected to a fixed component such as the knuckle (not shown) of the vehicle wheel, and the caliper body 210 connected to the pad carrier may move while being guided along the direction of the connecting pin. For example, during the braking operation, the caliper body 210 may be moved by a reaction force of the brake pad for applying a pressure to the brake disk. The direction of the connecting pin is parallel to the direction in which the brake pad is moved.

The pad carrier may be made of a metal-based material having appropriate strength to support a braking torque acting on the brake pad.

The brake pad may be composed of a pad that comes into direct contact with and rubs against the brake disk and a back plate connected to one surface of the pad. The brake pad may include a plurality of brake pads, and a first brake pad may press one side surface of the brake disk and a second brake pad may press the other side surface of the brake disk. A pair of brake pads may be placed in a state of facing each other with the brake disk interposed therebetween.

Although not shown in the drawing, the brake device 200 may include a motor for driving the pad moving unit 220 and a gear assembly composed of gears connected to the motor.

An operation of the motor may be controlled based on an electrical signal, and when the motor is operated, a rotational motion of the motor may be transmitted to the pad moving unit 220 via the gear assembly.

The gear assembly may be constructed as an assembly of a plurality of gears for transmitting the rotational motion of the motor. The plurality of gears may be connected to the motor gear, and there may be various structures, including types, the numbers, positions, sizes, and the like, of the plurality of gears devised by a person skilled in the art. The plurality of gears may be constructed as a combination of various gear types such as a spur gear, a helical gear, and a worm gear.

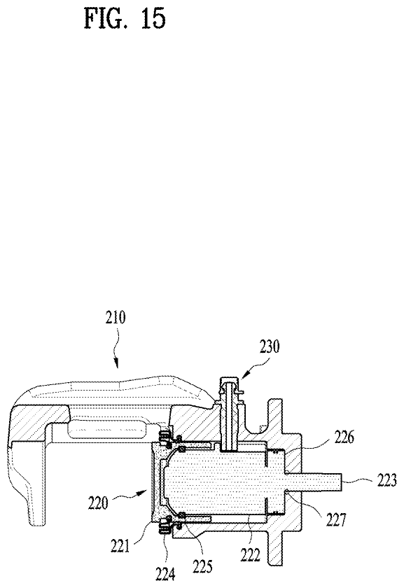

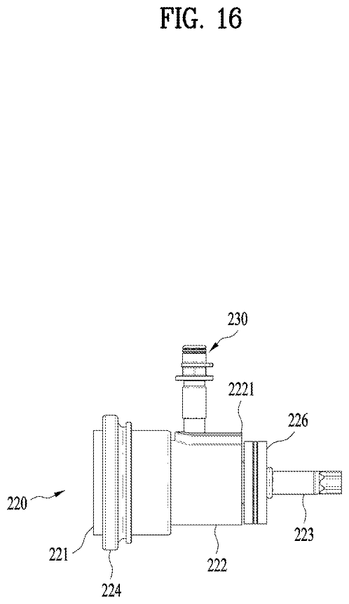

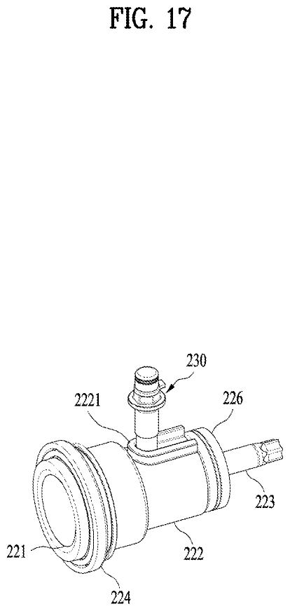

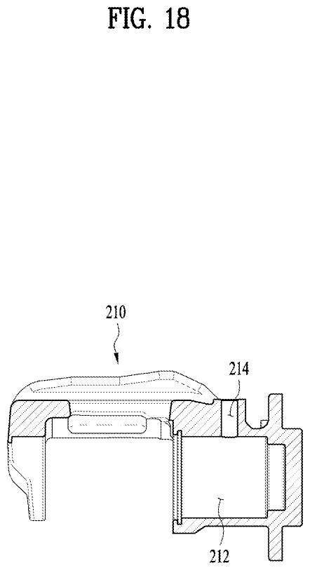

FIG. 15 is a cross-sectional view of FIG. 13, and FIG. 16 shows the pad moving unit 220 and the cylinder connection port 230. In addition, FIG. 17 is a perspective view of FIG. 16. FIG. 18 shows a cross-sectional view of the caliper body 210.

FIGS. 15 to 17 illustrate components of the pad moving unit 220 and the cylinder connection port 230 that are not visible from the outside. FIG. 18 shows the caliper body 210 except for the pad moving unit 220 and the cylinder connection port 230 in FIG. 16.

The pad moving unit 220 may receive power from the gear assembly to move the brake pad. Referring to FIGS. 15 to 17, the pad moving unit 220 includes the piston 221, conversion assembly 222 and 223, a piston seal portion 225, and/or the piston boot 224. The pad moving unit 220 may be referred to as an actuator.

The conversion assembly may represent various components capable of converting a rotational motion of the gear into a linear motion and a connection scheme of the components. For example, in the present embodiment, the conversion assembly includes a bolt screw 223 and a moving nut 222 corresponding thereto. The conversion assembly may be seated in the cylindrical portion 212. The cylindrical portion 212 may be a cylindrical space.

The bolt screw 223 is engaged with the gear connected to the motor and rotates around an axis. The bolt screw 223 may be positioned at a center of the cylindrical portion 212 to be directed in an axial direction. The axial direction of the bolt screw 223 is parallel to a direction in which the brake pad moves (advances or retreats). The bolt screw 223 is positioned within a space of the cylindrical portion 212 of the caliper body 210 and rotates in place. Although not shown in the drawings, the bolt screw 223 includes a helical screw thread on an outer surface thereof.

The moving nut 222 may have a screw corresponding to the screw thread of the bolt screw 223, and may be connected to the bolt screw 223 to move forward or backward based on a rotation direction of the bolt screw 223. The moving nut 222 may protrude out of the cylindrical portion 212 or be withdrawn into the cylindrical portion 212 while being connected to the bolt screw 223 and moving. The moving nut 222 may move along a length direction of the cylindrical portion 212.

A length of the moving nut 222 may be sufficiently great such that a head of the moving nut 222 may protrude out of the cylindrical portion 212 even when the moving nut 222 is inserted all the way into the cylindrical portion 212. That is, the length of the moving nut may be greater than a length of the cylindrical portion 212. When the bearing 226 is positioned inside the cylindrical portion 212, the length of the moving nut may be greater than the length of the cylindrical portion 212 minus a thickness of the bearing.

The pad moving unit 220 may further include the bearing 126 connected to the bolt screw 223. The bearing 126 may include one or more bearings 126, and the bearings 126 may be positioned at the rear of a tail of the moving nut 222. The bearing 126 may include a screw bearing and may constantly maintain a position of the bolt screw 223.

A portion of the moving nut 222 is positioned inside the cylindrical portion 212, and the movement of the moving nut 222 is guided by a direction of the cylindrical portion 212. The moving nut 222 may be referred to as a ball screw nut, and a structure of the bolt screw 223 and the moving nut 222 may be referred to as a ball screw structure.

One end of the piston 221 is connected to the brake pad and the other end thereof is connected to a head of the moving nut 222 to transmit the movement of the moving nut 222 to the brake pad. A shape of the piston 221 may include a cylindrical shape with one surface open, and the head of the moving nut 222 may be inserted into the piston 221 via the open surface and connected to the piston 221. That is, the head of the moving nut 222 (a portion protruding out of the cylindrical portion) is connected to the piston 221. Accordingly, when the moving nut 222 moves forward or backward, the piston 221 and the brake pad connected to the moving nut 222 may move forward or backward together.

Although not shown, a cross-sectional diameter of the piston 221 may be larger than that of the cylindrical portion 212 such that the piston 221 is not inserted into the space of the cylindrical portion 212. In this case, the piston 221 may be positioned outside the cylindrical portion 212.

The head of the moving nut 222 may include a curved surface, and the piston 221 may include a corresponding curved surface on one surface thereof close to the head of the moving nut 222. For example, when the head of the moving nut 222 includes a convex surface, the corresponding surface of the piston 221 may include a concave surface. The curved surface of the moving nut 222 and the curved surface of the piston 221 may correspond to each other and may be in contact with each other.

The piston seal portion 225 is a component that blocks a gap generated between the piston 221 and the head of the moving nut 222. The piston seal portion 225 blocks the foreign substances from entering the piston 221.

The moving nut 222 includes a first groove defined along a circumference of the head, and the piston 221 includes a second groove whose position corresponds to that of the first groove in an inner surface thereof. When the piston 221 and the moving nut 222 are connected to each other, the first groove and the second groove face each other, and a space in which the piston seal portion 225 may be positioned is defined by the first groove and the second groove. Accordingly, the piston seal portion 225 may be positioned in the space defined by the first groove of the moving nut 225 and the second groove of the piston 221. The piston seal portion 225 may have a shape formed along the space defined by the first groove of the moving nut 222 and the second groove, and may have a ring shape. The shape of the piston seal portion 225 may be applied differently depending on a cross-sectional shape of the moving nut 222. In addition, a cross-section of the piston seal portion 225 may be formed in a rectangular or circular shape, and shapes of the first groove and the second groove may be changed to correspond to the cross-sectional shape of the piston seal portion 225. The piston seal portion 225 may include parts, materials, and the like commonly used for sealing.

The piston seal portion 225 blocks the gap between the moving nut 222 and the piston 221 and connects the moving nut 222 and the piston 221 so as not to be separated from each other. In this regard, the moving nut 222 and the piston 221 may be connected to each other with a predetermined spacing between a surface of the head of the moving nut 222 and the inner surface of the piston 221. The predetermined spacing may be defined between the curved surface of the head of the moving nut 222 and the corresponding curved surface of the piston 221 in the absence of an external force. In this regard, the predetermined spacing may be equal to or smaller than 2 mm.

The piston 221 is capable of flexible movement within a range allowed by the predetermined spacing described above. Therefore, an axial direction of the piston 221 may be slightly inclined differently from an axial direction of the moving nut 222.

In a case in which the pad of the brake pad is asymmetrically worn, when the brake pad presses the brake disk, the brake pad receives an external force so as to be inclined because of an inclination of a pad surface that is worn at one side. However, because the brake pad of the brake device 200 according to the embodiment may be slightly inclined, a magnitude of an external force applied to the piston 221 or the moving nut 222 is significantly reduced and a possibility of breakage is low.

In addition, the spacing between the moving nut 222 and the piston 221 may improve a return performance of the brake pad and prevent a collision between the moving nut 222 and the piston 221 caused by vehicle vibration. Because the collision between the piston 221 and the moving nut 222 is prevented, noise of the device may be reduced and durability may be improved.

The moving nut 222 may allow the piston 221 to move forward only when moving forward by the above-mentioned arbitrary distance or more and then coming into contact with the piston 221 and transmitting the pressure to the piston 221. In case of backward movement, the moving nut 222 may allow the piston 221 to move backward only when moving backward by the corresponding distance or more. A section in which only the moving nut 222 moves without moving the piston 221 during the forward movement or the backward movement may be referred to as an invalid stroke section, and the invalid stroke section may be set to be equal to or smaller than 2 mm. That is, the aforementioned arbitrary distance may be set to be equal to or smaller than 2 mm.

A bolt seal portion 227 is a component that blocks a gap generated as the bolt screw 223 extends through the caliper body 210. The bolt seal portion 227 blocks the outside foreign substances from entering the cylindrical portion 212 or prevents the lubricant, the braking liquid, or the grease of the cylindrical portion 212 from leaking to the outside.

The piston boot 224 blocks a gap between an edge of an outer wall of the cylindrical portion 212 and an outer surface of the moving nut 222 (or the piston) to block the inflow of the foreign substances from the outside.

The cylindrical portion 212 includes a third groove defined along an inner edge thereof, and the piston 221 includes a fourth groove defined along a circumference of an outer circumferential surface thereof. The fourth groove is positioned outside the cylindrical portion 212. One end of the piston boot 224 is inserted into and fixed to the third groove, and the other end of the piston boot 224 is inserted into and fixed to the fourth groove. The piston boot 224 is formed with a plurality of creases, so that the piston boot 224 may be flexibly deformed even when a position of the moving nut 222 (or the piston) changes, and may block a space between the moving nut 222 (or the piston) and the cylindrical portion 212 from the outside. Therefore, the foreign substances may be prevented from entering the space of the cylindrical portion 212 from the outside.

When the piston 221 is always positioned outside the cylindrical portion 212 (when the length of the moving nut is great), the aforementioned fourth groove may be defined along a circumference of an outer circumferential surface of the moving nut 222. In this regard, one end of the boot may be fixed to the fourth groove, so that the boot may block the gap between the edge of the cylindrical portion 212 and the moving nut 222 from the outside.

The caliper body 210 may include a fifth groove defined along an outer circumference of the hole through which the bolt screw 223 extends, and the fifth groove provides a space for the bolt seal portion 227 to be positioned. The bolt seal portion 227 is positioned in the fifth groove to block a gap along the circumference of the bolt screw 223. The bolt seal portion 227 may have a shape formed along the space defined by the fifth groove and may include a ring shape. A cross-section of the bolt seal portion 227 may be formed in a rectangular or circular shape, and a shape of the fifth groove may be changed to correspond to the cross-sectional shape of the bolt seal portion 227. The bolt seal portion 227 may include parts, materials, and the like commonly used for sealing.

In one example, in the brake device 200, one conversion assembly may be disposed regardless of the number of pistons. When there are a plurality of pistons, the plurality of pistons may be moved integrally by one conversion assembly. Because a separate conversion assembly is not required for each piston, cost and weight may be reduced and a surface pressure of the brake pad may be improved.

For example, two pistons may be connected for one conversion assembly. In this regard, a portion of the moving nut may be connected to the bolt screw while being positioned within the cylindrical portion, and other portions thereof may be inserted into and connected to the plurality of pistons. The portions of the moving nut inserted into and connected to the plurality of pistons may be referred to as connecting portions. The moving nut includes a plurality of connecting portions that may be respectively connected to the plurality of pistons.

The plurality of pistons may be positioned outside the cylindrical portion, and similarly, the connecting portions may be positioned outside the cylindrical portion.

Each of the connection portions may include a first groove defined along a circumference thereof, and each of the pistons connected to each of the connection portions may include a second groove whose position corresponds to that of the first groove in an inner surface thereof. In addition, the seal portion may be positioned in a space defined by the first groove and the second groove. That is, each of the plurality of pistons may be connected to each of the plurality of connecting portions by the seal portion. In addition, a predetermined gap may be defined between a surface of each of the connecting portions and an inner surface of each of the piston. In this regard, the gap may be equal to or smaller than 2 mm.

In the brake device 200, the conversion assembly may further include various structures that may be devised by a person skilled in the art in addition to the ball screw structure. For example, a combination of a rack gear and a pinion gear may convert the rotation of the gear into the linear motion.

Referring to FIGS. 15 to 17, the brake device 200 may include the cylinder connection port 230.

The cylinder connection port 230 may be positioned in the passage 214 of the caliper body 210, provide a flow channel through which the fluid (gas or liquid) may be transported, and may include a cap capable of opening and closing the flow channel. A length of the flow channel of the cylinder connection port 230 is greater than a length of the passage 214 of the caliper body 210. Accordingly, when the cylinder connection port 230 is inserted into the passage 214, an end of the cylinder connection port 230 may protrude beyond an outer surface of the caliper body 210.

Referring to FIG. 15, an end of the cylinder connection port 230 installed in the passage 214 further protrudes toward the moving nut 222 from an outer wall of the space of the cylindrical portion 212. An end of the cylinder connection port 230 further protrudes inward from an edge of the cylindrical portion 212. The moving nut 222 may include a guide 2221 that may be engaged with the end of the cylinder connection port 230 on a side surface thereof. The moving nut 222 includes the guide 2221 that is engaged with the end of the cylinder connection port 230 in a slidable manner.

The guide 2221 has a groove into which the end of the cylinder connection port 230 may be inserted, and the groove extends in a length direction of the moving nut 222. Therefore, when the moving nut 222 moves forward or backward, a relative position of the end of the cylinder connection port 230 within the groove of the guide 2221 changes.

Because the position of the cylinder connection port 230 in the caliper body 210 is fixed and the protruding end of the cylinder connection port 230 is inserted into the groove of the guide 2221 of the moving nut 222, the rotation of the moving nut 222 is limited. When the moving nut 222 rotates as the bolt screw 223 rotates, the rotational motion of the bolt screw 223 cannot be completely converted into the linear motion. That is, the moving nut 222 cannot move as much as a straight line distance corresponding to the rotation of the bolt screw 223. The moving nut 222 according to the embodiment may be prevented from rotating by the guide 2221 engaged with the protruding end of the cylinder connection port 230, and may move in the straight line as much as the rotation of the bolt screw 223.

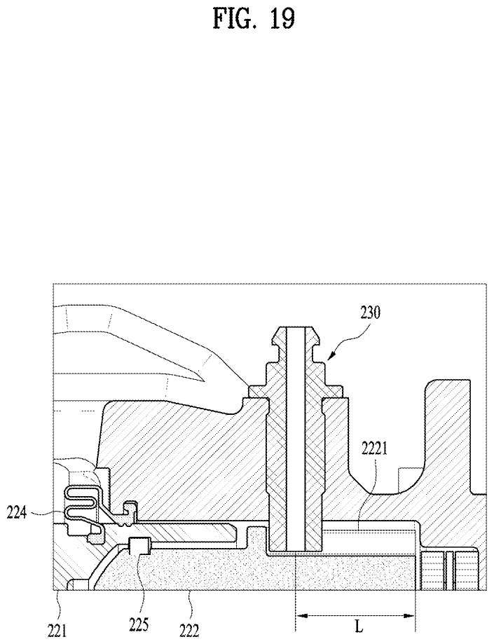

FIG. 19 is a cross-sectional view of the brake device 200, and is an enlarged view of a partial area. Referring to FIG. 19, a connection relationship between the cylinder connection port 230 and the moving nut 222 is shown.

A length L by which the guide 2221 extends is great enough in consideration of the forward or backward movement distance of the moving nut 222. Preferably, the length by which the guide 2221 extends may be twice or greater than the maximum wear amount of the brake pad. As the wear amount of the brake pad increases, the moving nut 222 must move a greater distance until the brake pad comes into contact with the brake disk. In addition, considering a wear amount of a brake disk on an opposite side, the moving nut 222 may have to move by the length twice or greater than the maximum wear amount of the brake pad. Therefore, the length of the guide 2221 may be twice or greater than the maximum wear amount of the brake pad. A standard for the maximum wear amount of the brake pad may be determined by conditions such as a type of the brake pad, a design condition, and the like.

An opening positioned at the end of the cylinder connection port 230 does not completely come into close contact with the outer surface of the moving nut 222 and is spaced apart therefrom by a predetermined spacing. Therefore, because the opening is not closed by the moving nut 222, the gas or the liquid injected via the cylinder connection port 230 may smoothly flow into the space of the cylindrical portion 212.

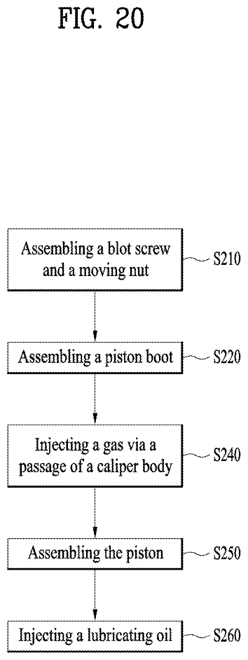

FIG. 20 shows a method for assembling the brake device 200. The method for assembling the brake device 200 according to an embodiment includes assembling the bolt screw 223 and the moving nut 222 to the caliper body 210 (S210) and assembling the piston boot 224 (S220). Further, the assembling method further includes injecting the gas into the cylindrical portion 212 via the passage 214 of the caliper body 210 (S240) and assembling the piston 221 (S250). In addition, the assembling method includes injecting the lubricating oil, the braking liquid, or the grease into the cylindrical portion 212 via the passage 214 (S260).

In addition, the method for assembling the brake device may include assembling the conversion assembly (the bolt screw and the moving nut) to the cylindrical portion 212 of the caliper body 210, assembling the piston boot 224 to the opening of the cylindrical portion 212, injecting the gas into the cylindrical portion 212 via the passage 214 of the caliper body 210, and connecting and assembling the piston 221 to the piston boot 224.

The assembling method according to the embodiments helps to install the piston 221 in the unfolded state of the piston boot 224 by injecting air into the cylindrical portion 212 with respect to the installed piston boot 224. Therefore, ease of assembly of the piston 221 may be improved.

The brake device 200 may have the passage 214 in the caliper body 210 to transfer the gas or the liquid from the outside into the space of the cylindrical portion 212. Accordingly, frictional resistance resulted from repeated braking operations is reduced and durability of the device is improved by injecting the lubricating oil, the braking liquid, or the grease into the space of the cylindrical portion 212 where the pad moving unit 220 is seated.

In addition, the protruding end of the cylinder connection port 230 positioned in the passage 214 may be engaged with the moving nut 222 to suppress the rotation of the moving nut 222, thereby improving the linear behavior of the moving nut 222.

The brake device 200 does not directly come into contact with the caliper body 210 when the piston 221 connected to the brake pad is positioned outside the cylindrical portion 212. In this regard, because the caliper body 210 does not require the cylindrical portion 212 for accommodating the piston, a size and a volume of the cylindrical portion 212 may be reduced, and a weight and a manufacturing cost may be reduced.

The brake device 200 may improve the surface pressure of the brake pad by applying the plurality of pistons to one brake pad. Regardless of the caliper body 210, the plurality of pistons may be applied by taking advantage of the advantage of reducing the size of the piston, and the plurality of pistons may equally improve the surface pressure of the brake pad.

It is understood that the descriptions of the various embodiments of the present disclosure are not limited only for the corresponding embodiments, and the technical idea of each embodiment applied in the various embodiments are also applicable to other embodiments.

The detailed descriptions of the preferred embodiments of the present disclosure disclosed as described above have been provided to enable those skilled in the art to implement and practice the present disclosure. Although described above with reference to the preferred embodiments of the present disclosure, those skilled in the art will be able to understand that the present disclosure may be variously modified and changed without departing from the scope of the present disclosure. For example, those skilled in the art may use the components described in the above-described embodiments in a manner of combining the components with each other.

The present disclosure is not intended to be limited to the embodiments described herein, but is to be accorded the widest scope consistent with the principles and novel features disclosed herein.

What is claimed is:

1. A brake device comprising:
a brake pad;
a pad moving unit connected to the brake pad and configured to linearly move the brake pad;
a caliper body having a cylindrical portion for the pad moving unit to be seated therein; and
a motor-gear assembly connected to the pad moving unit and configured to transmit power of a motor,
wherein the pad moving unit includes a conversion assembly for converting a rotational motion into a linear motion, and a piston connected to one end of the conversion assembly,
wherein the piston is positioned outside the cylindrical portion, and
wherein the motor-gear assembly is fixed with respect to the caliper body.

2. The brake device of claim 1, wherein the conversion assembly includes:
a bolt screw rotating around an axis; and
a moving nut connected to the bolt screw,
wherein the moving nut moves by the rotation of the bolt screw,
wherein one end of the bolt screw protrudes to the outside of the caliper body,
wherein the one end of the bolt screw is connected to a gear, and
wherein the gear is rotated by the motor.

3. The brake device of claim 2, wherein the bolt screw is capable to move a predetermined distance in a direction of the axis,
wherein the bolt screw and the gear are capable of being engaged with each other and rotating in a section equal to or greater than the predetermined distance.

4. The brake device of claim 3, wherein the bolt screw has a first shape capable of being engaged with the gear,
wherein the gear has a second shape capable of being engaged with the first shape, and
wherein the first shape or the second shape extends by a distance equal to or greater than the predetermined distance in the axial direction.

5. The brake device of claim 4, wherein the second shape of the gear is a hole capable of receiving the one end of the bolt screw therein,
wherein the brake device further includes a gear casing for accommodating the gear and the motor therein, and
wherein the gear casing is fixed with respect to the motor and the gear assembly.

6. The brake device of claim 1, further comprising a gear boot having one end fixed to the caliper body and the other end fixed to the gear casing.

7. The brake device of claim 1, further comprising a nut boot having one end fixed to the cylindrical portion and the other end fixed to the moving nut.

8. The brake device of claim 7, wherein one end of the moving nut is inserted into the piston,
wherein the one end of the moving nut includes a first groove defined therein along a circumference thereof,
wherein the piston includes a second groove in an inner surface thereof at a position corresponding to a position of the first groove, and
wherein the brake device further includes a seal portion positioned in a space defined by the first groove and the second groove.

9. The brake device of claim 8, wherein a surface of the one end of the moving nut and the inner surface of the piston are spaced apart from each other by an arbitrary distance, wherein the arbitrary distance is equal to or smaller than 2 mm.

10. The brake device of claim 9, wherein the cylindrical portion includes a third groove defined therein along an edge of an opening,
wherein the moving nut includes a fourth groove defined therein along a circumference of an outer circumferential surface thereof, and
wherein the nut boot is fixed by the third groove and the fourth groove.

11. A brake device comprising:
a pad moving unit for linearly moving a brake pad; and
a caliper body having a cylindrical portion for the pad moving unit to be seated therein,
wherein a portion or an entirety of the pad moving unit is able to be inserted into the cylindrical portion, and a space of the cylindrical portion is opened in a direction toward the brake pad,
wherein the pad moving unit is configured to operate in connection with the motor, and
wherein the caliper body includes a passage extending through an edge of the space of the cylindrical portion and connected to the outside of the caliper body.

12. The brake device of claim 11, wherein the pad moving unit includes:
a conversion assembly for converting a rotational motion into a linear motion; and
a piston connected to one end of the conversion assembly,
wherein the conversion assembly is seated inside the cylindrical portion, and
wherein the conversion assembly includes:
a bolt screw rotating around an axis; and
a moving nut coupled to a screw thread of the bolt screw, and
wherein the moving nut moves along a direction of the cylindrical portion by the rotation of the bolt screw.

13. The brake device of claim 12, wherein the moving nut has one end inserted into the piston, and the one end of the moving nut includes a first groove defined therein along a circumference thereof,
wherein the piston includes a second groove defined in an inner surface thereof at a position corresponding to a position of the first groove, and
wherein the brake device further includes a seal portion positioned in a space defined by the first groove and the second groove.

14. The brake device of claim 13, wherein a surface of the one end of the moving nut and the inner surface of the piston are spaced apart from each other by a predetermined distance,
wherein the predetermined distance is equal to or smaller than 2 mm.

15. The brake device of claim 14, wherein the cylindrical portion includes a third groove defined therein along the edge of the space,
wherein the piston includes a fourth groove defined therein along a circumference of an outer circumferential surface thereof,
wherein the brake device further includes a boot for blocking a space defined between an outer surface of the moving nut and an edge of the cylindrical portion from the outside, and
wherein the boot is fixed by the third groove and the fourth groove.

16. The brake device of claim 12, wherein gas or liquid is transferred from the outside of the caliper body to the cylindrical portion via the passage, and
wherein the brake device further comprises a cylinder connection port positioned in the passage and having a flow channel defined therein leading from the outside of the caliper body to the cylindrical portion.

17. The brake device of claim 16, wherein the cylinder connection port is able to open and close the flow channel,
wherein one end of the cylinder connection port protrudes inwards from the edge of the cylindrical portion,
wherein the moving nut includes a guide slidably engaged with the one end of the cylinder connection port, and
wherein a predetermined gap is defined between an opening of the flow channel defined at the one end of the cylinder connection port and the moving nut.

18. The brake device of claim 17, wherein the guide has a length twice or greater than a maximum wear amount of the brake pad.

19. A method for assembling a brake device, the method comprising:
assembling a conversion assembly to a cylindrical portion of a caliper body;
assembling a piston boot to an opening of the cylindrical portion;
injecting gas into the cylindrical portion via a passage of the caliper body; and
connecting and assembling a piston to the piston boot.
